(19) United States
(12) Patent Application Publication
(10) Pub. No.: US 2019/0339842 A1
(43) Pub. Date: Nov. 7, 2019

(54) ICON DISPLAY STRUCTURE OF ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHUN-KAI PENG, New Taipei (TW); WEI-CHIEN HSU, New Taipei (TW); YING-CHIA TANG, New Taipei (TW); YING-WEI SHENG, New Taipei (TW); CHIA-WEI LIU, New Taipei (TW); YAN-CHANG HE, Shenzhen (CN)

(21) Appl. No.: 16/208,041

(22) Filed: Dec. 3, 2018

(30) Foreign Application Priority Data
May 4, 2018 (CN) 201810421939.3

(51) Int. Cl. G06F 3/0481; G09G 3/22; G02B 5/02

(52) U.S. Cl. CPC G06F 3/04817; G02B 5/0205; G09G 3/22

(57) ABSTRACT

An icon display structure includes a display panel including a silkscreen interlayer, a diffusion sheet, and a light source. The diffusion sheet includes a light transmission zone. The silkscreen interlayer includes a silkscreen icon and defines a hollow icon. The silkscreen icon is aligned with the hollow icon and appears directly on the display panel. The light transmission zone of the diffusion sheet is aligned with the silkscreen icon and the hollow icon. The light source is positioned behind the diffusion sheet. The light source emits light and the light transmits through the light transmission zone and the hollow icon to light up the silkscreen icon on the display panel.

### FIELD

The subject matter herein generally relates to electronic devices, and more particularly to an icon display structure of an electronic device.

### BACKGROUND

Generally, electronic devices have buttons to initiate various functions of the electronic devises. For example, pressing a power button of the electronic device initiates turning on or turning off the electronic device. A location of the button on the electronic device may be indicated by an icon on the electronic device. However, sometimes the icons are not conveniently located for visibility.

### BRIEF DESCRIPTION OF THE DRAWINGS

Implementations of the present disclosure will now be described, by way of embodiments, with reference to the attached figures.

FIG. 1 is an exploded, isometric view of an icon display structure in accordance with an embodiment of the present disclosure.

FIG. 2 is an exploded, isometric view of a display panel of the icon display structure in FIG. 1.

FIG. 3 is another exploded, isometric view of the display panel in FIG. 2.

FIG. 4 is a front view of the display panel.

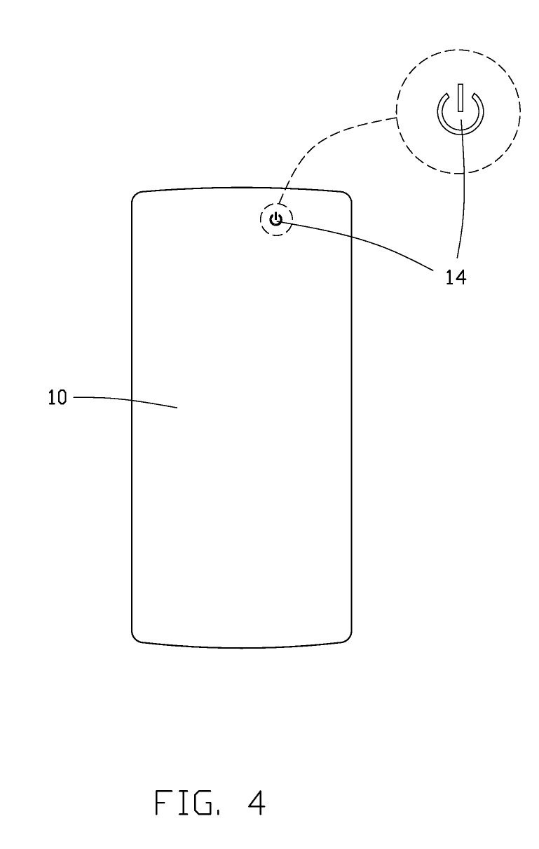

FIG. 5 is a rear view of the display panel.

FIG. 6 is a front view of a diffusion sheet of the icon display structure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

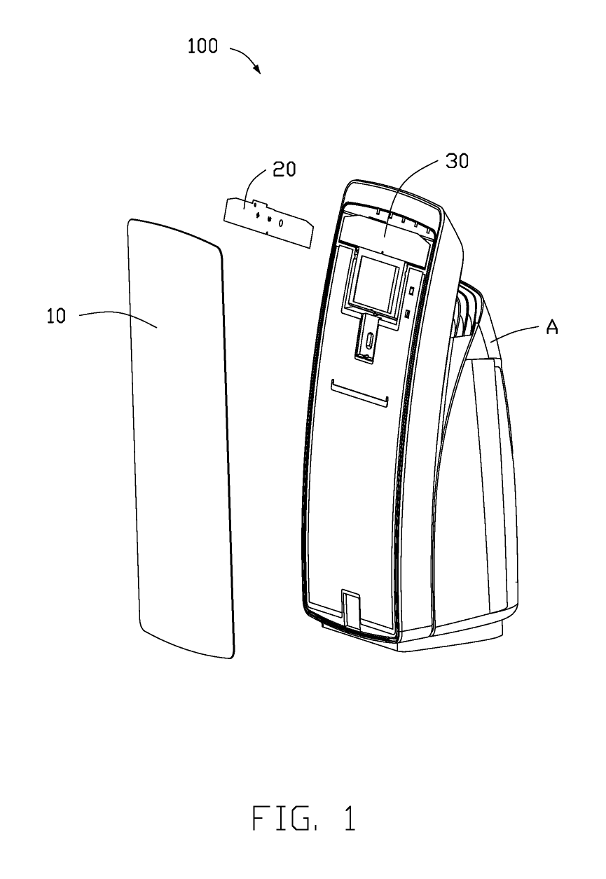

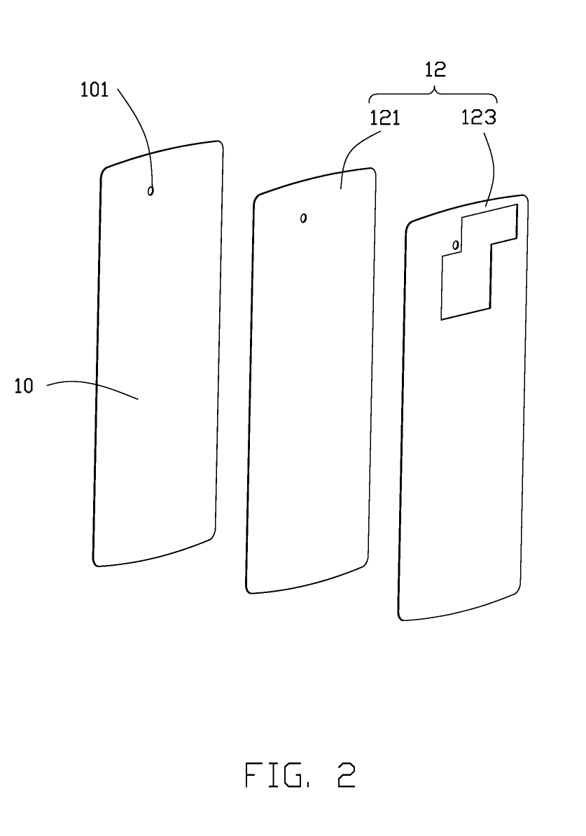

FIG. 1 and FIG. 2 show an embodiment of an icon display structure 100 in an electronic device A. In one embodiment, the electronic device A is an air purifier. The icon display structure 100 includes a display panel 10, a diffusion sheet 20, and a light source 30. The display panel 10 is mounted on a front surface of the electronic device A. The diffusion sheet 20 and the light source 30 are mounted in sequence and covered by the display panel 10. In one embodiment, the display panel 10 includes a silkscreen interlayer 12 on a rear surface thereof facing the diffusion sheet 20. The silkscreen interlayer 12 includes a background layer 121 and a base layer 123. The background layer 121 and the base layer 123 are screen printed in sequence on the rear surface of the display panel 10.

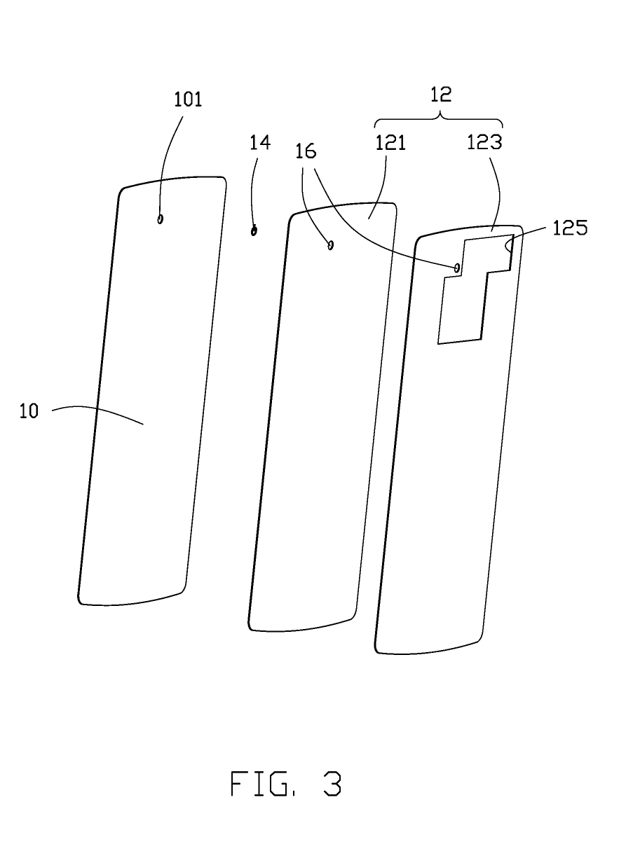

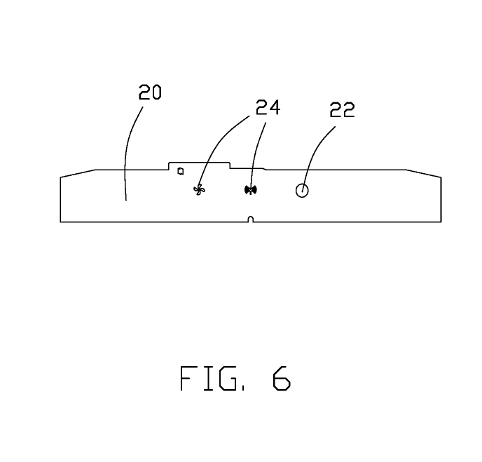

As shown in FIG. 3, the silkscreen interlayer 12 includes a silkscreen icon 14 and a hollow icon 16. The silkscreen icon 14 is aligned with the hollow icon 16. The silkscreen icon 14 is screen printed directly on the rear surface of the display panel 10 so that the silkscreen icon 14 appears directly on the display panel 10. The background layer 121 covers the silkscreen icon 14 and a rear surface of the display panel 10. The base layer 123 covers the background layer 121 and the rear surface layer 20 includes a light transmission zone 22 (shown in FIG. 6). The light transmission zone 22 is aligned with the silkscreen icon 14 and the hollow icon 16. The light source 30 is positioned behind the diffusion sheet 20. The silkscreen icon 14 is lit up on the display panel 10 by the light source 30 emitting light. Thus, the silkscreen icon 14 screen printed on the display panel 10 appears directly on the display panel 10 and is lit up on the display panel 10 by the light source 30.

As shown in FIG. 3, the silkscreen icon 14 is screen printed on a silkscreen position 101 of the display panel 10. The background layer 121 and the base layer 123 each include the hollow icon 16. In one embodiment, the silkscreen icon 14 is a power button symbol, and the hollow icon 16 is a hollow power button symbol. The silkscreen icon 14 is aligned with the hollow icons 16, so that the power button symbol is aligned with the hollow power button symbol.

In use, the silkscreen icon 14 appears on a front surface of the display panel 10. When the electronic device A is not powered on, a user is able to conveniently find the power button symbol of the silkscreen icon 14 to turn on the electronic device A. In one embodiment, the display panel 10 is an acrylic light board. The silkscreen icon 14 is screen printed with translucent silver paint. The background layer 121 is screen printed with a display paint. The base layer 123 is screen printed with a masking paint. In one embodiment, a color of the display paint is pearl white, and a color of the masking paint is black or a dark-colored paint.

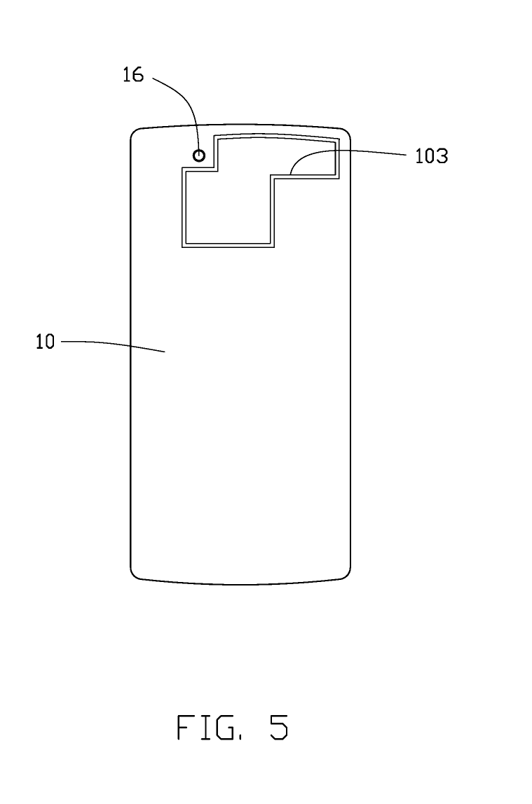

As shown in FIG. 5, the power button symbol of the silkscreen icon 14 can be seen from a rear side of the display panel 10 through the hollow icon 16. The base layer 123 of the silkscreen interlayer 12 further includes a hollow display zone 125 (also shown in FIG. 3). The hollow display zone 125 forms a translucent display zone 103 on the rear surface of the display panel 10 through the base layer 123. The translucent display zone 103 is aligned with the diffusion sheet 20.

Referring to FIG. 6, a size of the light transmission zone 22 of the diffusion sheet 20 is greater than a size of the silkscreen icon 14. The light transmission zone 22 is aligned with the silkscreen position 101. In one embodiment, the light transmission zone 22 is round. The silkscreen icon 14 is aligned with the hollow icons 16 of the background layer 121 and the base layer 123. The light transmission zone 22 of the diffusion sheet 20 is aligned with the silkscreen icon 14 located in the silkscreen position 101. When the light source 30 emits light, the light emitted by the light source 30 passes through the light transmission zone 22, the hollow icons 16, and the silkscreen icon 14 to light up the silkscreen icon 14. Thus, the power button symbol of the silkscreen icon 14 is lit up on the display panel 10.

The area of the diffusion sheet 20 outside of the light transmission zone 22 is a non-transparent zone. A plurality of light transmission icons 24 are located in the non-transparent zone. In one embodiment, the plurality of light transmission icons 24 include a fan icon and a detection icon. The light transmission icons 24 are aligned with the translucent display zone 103 of the display panel 10 and are displayed on the display panel 10 when the light source 30 emits light to the diffusion sheet 20. Thus, when the light source 30 emits light, the silkscreen icon 14 is lit up and the plurality of light transmission icons 24 are displayed on the display panel 10. Thus, a user can conveniently see the silkscreen icon 14 and the plurality of light transmission icons 24 to operate the electronic device A.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An icon display structure comprising:
a display panel comprising a silkscreen interlayer;
a diffusion sheet comprising a light transmission zone; and
a light source; wherein:
the silkscreen interlayer comprises a silkscreen icon and defines a hollow icon;
the silkscreen icon is aligned with the hollow icon and appears on the display panel;
the light transmission zone of the diffusion sheet is aligned with the silkscreen icon and the hollow icon;
the light source is positioned facing the diffusion sheet; and
the silkscreen icon on the display panel is lit up by light emitted from the light source, transmitted through the light transmission zone and the hollow icon.

2. The icon display structure of claim 1, wherein:
the silkscreen icon is screen printed on the rear surface of the display panel;
the silkscreen interlayer comprises a background layer and a base layer screen printed in sequence on the rear surface of the display panel;
the background layer covers the silkscreen icon and a rear surface of the display panel; and
the base layer covers the background layer.

3. The icon display structure of claim 2, wherein:
the silkscreen icon is located on a silkscreen position of the rear surface of the display panel;
the background layer and the base layer each defines a hollow icon aligned with the silkscreen icon.

4. The icon display structure of claim 3, wherein:
the silkscreen icon is a power button symbol;
the hollow icon is a hollow power button symbol.

5. The icon display structure of claim 2, wherein:
the display panel is an acrylic light board;
the silkscreen icon is screen printed with translucent silver paint;
the background layer is screen printed with a display paint;
the base layer is screen printed with a masking paint.

6. The icon display structure of claim 5, wherein:
a color of the display paint is pearl white; and
a color of the masking paint is a dark-colored paint.

7. The icon display structure of claim 2, wherein:
the base layer further comprises a hollow display zone;
the hollow display zone forms a translucent display zone on the display panel through the background layer.

8. The icon display structure of claim 7, wherein:
a size of the light transmission zone of the diffusion sheet is larger than a size of the silkscreen icon;
the light transmission zone is aligned with the silkscreen icon;
the silkscreen icon is lit up on the display panel by light emitted from the light source and transmitted through the light transmission zone.

9. The icon display structure of claim 8, wherein:
the diffusion sheet further comprises a plurality of light transmission icons;
the plurality of light transmission icons are displayed on the display panel by light emitted from the light source and transmitted through the plurality of light transmission icons.

10. The icon display structure of claim 9, wherein:
the translucent display zone of the display panel is aligned with the diffusion sheet;
the plurality of light transmission icons are displayed on the translucent display zone of the display panel by light emitted from the light source to the diffusion sheet.

11. An electronic device comprising an icon display structure comprising:
a display panel comprising a silkscreen interlayer;
a diffusion sheet comprising a light transmission zone; and
a light source; wherein:
the silkscreen interlayer comprises a silkscreen icon and defines a hollow icon;
the silkscreen icon is aligned with the hollow icon and appears on the display panel;
the light transmission zone of the diffusion sheet is aligned with the silkscreen icon and the hollow icon;
the light source is positioned facing the diffusion sheet; and
the silkscreen icon on the display panel is lit up by light emitted from the light source, transmitted through the light transmission zone and the hollow icon.

12. The electronic device of claim 11, wherein:
the silkscreen icon is screen printed on the rear surface of the display panel;
the silkscreen interlayer comprises a background layer and a base layer screen printed in sequence on the rear surface of the display panel;
the background layer covers the silkscreen icon and a rear surface of the display panel; and
the base layer covers the background layer.

13. The electronic device of claim 13, wherein:
the silkscreen icon is located on a silkscreen position of the rear surface of the display panel;
the background layer and the base layer each defines a hollow icon aligned with the silkscreen icon.

14. The electronic device of claim 13, wherein:
the silkscreen icon is a power button symbol;
the hollow icon is a hollow power button symbol.

15. The electronic device of claim 12, wherein:
the display panel is an acrylic light board;
the silkscreen icon is screen printed with translucent silver paint;
the background layer is screen printed with a display paint;
the base layer is screen printed with a masking paint.

16. The electronic device of claim 15, wherein:
a color of the display paint is pearl white; and
a color of the masking paint is a dark-colored paint.

17. The electronic device of claim 12, wherein:
the base layer further comprises a hollow display zone;
the hollow display zone forms a translucent display zone on the display panel through the background layer.

18. The electronic device of claim 17, wherein:
a size of the light transmission zone of the diffusion sheet is larger than a size of the silkscreen icon;
the light transmission zone is aligned with the silkscreen icon;
the silkscreen icon is lit up on the display panel by light emitted from the light source and transmitted through the light transmission zone.

19. The electronic device of claim 18, wherein:
the diffusion sheet further comprises a plurality of light transmission icons;
the plurality of light transmission icons are displayed on the display panel by light emitted from the light source and transmitted through the plurality of light transmission icons.

20. The electronic device of claim 19, wherein:
the translucent display zone of the display panel is aligned with the diffusion sheet;
the plurality of light transmission icons are displayed on the translucent display zone of the display panel by light emitted from the light source to the diffusion sheet.
